(19) United States
(12) Patent Application Publication
(10) Pub. No.: US 2024/0056790 A1
(43) Pub. Date: Feb. 15, 2024

(54) METHOD FOR SELECTIVELY BLOCKING SUBSCRIBER DATA WHILE ROAMING

(71) Applicant: T-Mobile USA, Inc., Bellevue, WA (US)

(72) Inventor: Raymond Thomas Ball, Seattle, WA (US)

(21) Appl. No.: 17/888,316

(22) Filed: Aug. 15, 2022

(51) Int. Cl. H04W 8/18; H04W 4/02

(52) U.S. Cl. CPC H04W 8/183; H04W 4/02; H04W 60/00

(57) ABSTRACT

Techniques for selectively blocking/unblocking data roaming for outbound user equipment (UE) by modifying subscriber data, are discussed herein. The present system may configure a roaming steering component to query a subscriber server of a home network operator for an account profile. The roaming steering component may use the account profile to selectively modify subscriber data to enable or disable data roaming and/or roaming network services for individual subscribers. The roaming steering component may also enable the home network operator to determine a distribution for outbound traffic of the outbound UE to a preferred partner.

### BACKGROUND

Modern telecommunication systems include heterogeneous mixtures of second, third, fourth, and fifth generation (2G, 3G, 4G, 5G) cellular wireless access technologies, which may be cross-compatible and may operate collectively to provide communication services. Global Systems for Mobile (GSM) is an example of 2G telecommunications technologies; Universal Mobile Telecommunications System (UMTS) is an example of 3G telecommunications technologies; Long Term Evolution (LTE), including LTE Advanced, and Evolved High-Speed Packet Access (HSPA+) are examples of 4G telecommunications technologies; and New Radio (NR) is an example of 5G telecommunication technologies. Previous 5G NR launches used existing legacy 4G LTE infrastructure in Non-Standalone (NSA) mode, and the next generation system (5GS) is transitioning to use 5G Core (5GC) infrastructure in Standalone (SA) mode.

To take advantage of the wireless communication technologies globally, devices configured for telecommunications are capable of communicating, not only via various types of communication applications but also via various types of networks from providers around the world. These interworking networks enable subscriber connectivity, whether at a home or at a foreign destination, to support the infrastructure and systems while roaming.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example system including user equipment and networks configured to selectively block subscriber data while roaming.

FIG. 2 is a block diagram of a user equipment configured to selectively block subscriber data while roaming.

FIG. 3 is a block diagram of a network device configured to selectively block subscriber data while roaming.

FIG. 4 illustrates an example process for selectively blocking subscriber data while roaming.

FIG. 5 illustrates another example process for selectively blocking subscriber data while roaming.

### DETAILED DESCRIPTION

Techniques for configuring a network system that supports selectively blocking subscriber data while user equipment (UE) is at a roaming location, are discussed herein. In an example traditional roaming network, a home network operator may define a default roaming policy (e.g., data roaming is enabled for all subscribers at Country A) for all UEs visiting a foreign location served by foreign network operators. Using a traditional roaming steering component, the home network operator may control roaming network traffic by applying the same default roaming policy for all UEs at the foreign location to steer the traffic to a group of partner network operators.

For example, in the traditional roaming network, the home network operator may define a “Country A Policy” for the partner network operators of Country A, and all roaming UEs traveling into Country A may operate under the same “Country A Policy.” If the “Country A Policy” indicates data roaming is enabled, then all roaming UEs may have data roaming enabled. Alternatively, if the “Country A Policy” indicates data roaming is disabled, then all roaming UEs may have data roaming disabled.

In various examples, the cost of data roaming in some foreign countries may be prohibitively expensive for most casual subscribers, thus the system may set the roaming policy to block all subscribers from data roaming in these high-cost roaming networks. However, in some cases, even for extremely high-cost locations, there are users associated with government or business entities that need data roaming services for some specific extremely high-cost locations. Accordingly, the network may enable data roaming services in these specific extremely high-cost locations. With the high-cost data roaming services is enabled, some amount of use for the casual subscribers may be recorded and billed from the extremely high-cost roaming network. In most instances, the casual subscribers are able to heed warnings of high-cost and refrain from using data roaming. In some instances, the casual subscribers may decide to pay the high-cost data for specific emergency uses. In some additional instances, a small portion of casual subscribers may be unaware of what “prohibitively expensive” means until they receive a phone bill for thousands of dollars. This small portion of casual subscribers may be distressed from potential insolvency, may complain, and request a write-off. The write-offs for these situations may lead to revenue loss in the millions over time.

The present network system improves the functionality of a roaming steering component by allowing the home network operator to enable or disable data roaming and/or specific roaming network services at an individual subscriber level. As described herein, traditionally, the home network operator would apply a location-wide (location level) roaming policy, so the roaming steering component is unable to block data roaming at the individual subscriber level. The present system configures the roaming steering component to selectively control data roaming for individual subscribers. The system may also enable the home network operator to determine a distribution for outbound traffic of roaming UEs to preferred partners. The preferred partners may be determined by the system based on benefits, including lower prices and/or higher service quality.

In some examples, the system may configure UE to support selective roaming functions. The system may configure a Subscriber Identity Module (SIM) profile for a UE to access a home network. The SIM profile may be associated with subscriber account information, including an account type and/or account indicators. The account type may indicate a government or business entity account type. The account indicators may indicate which network service(s) to enable/disable while the UE is at a roaming location. For instance, a cellphone may use a SIM card with the SIM profile that enables data roaming and a restricted set of network services (e.g., calls enabled at all hours and data enabled during specific hours). The cellphone and the SIM card may be assigned to a government employee and may be associated with a subscriber account, indicating the account type is a government account type, and the government account type may have data roaming enabled in all foreign partners networks.

In some examples, the system may configure a home subscriber server (“subscriber server”) that includes a roaming steering component and a subscriber database. The roaming steering component and the subscriber database may work in conjunction to provide subscriber profile updates, at real-time or near real-time. In various examples, the roaming steering component may be maintained by the subscriber server or by a third-party roaming management server. The subscriber database may be configured to store subscriber account profiles including subscription-related information and roaming-related information. The subscription-related information may include, but is not limited to, user information, subscriber account information (“subscription information”), billing information, account type, associated account(s), and the like. The account type may indicate whether the account is associated with an entity (e.g., corporation, government, etc.). The roaming-related information may include, but is not limited to, general roaming policy, roaming policy of associated roaming location, account indicators for services to unblock or block, access policy, roaming data limit, and the like.

The roaming steering component of a home network may detect a UE has traveled outbound to a visited country (roaming location) and may determine that subscriber account information is needed to determine service treatment for registering the UE on a roaming network. In some examples, the roaming steering component may receive a request for subscriber data from the roaming network. The request may include data to identify the UE to the home network. The data may include an account identifier (e.g., SIM profile), a visited country code, and current geolocation data associated with the UE. The roaming steering component may query a subscriber database via a subscriber server. In response to the query, the subscriber server may authenticate the account identifier, verify the visited country code based on the current geolocation data, and/or retrieve the subscriber account information, including roaming account type and/or account indicators for the visited country. The roaming steering component may receive subscriber data, including the subscriber account information. In some examples, the roaming steering component may call one or more commands Insert Subscriber Data-Request/Answer (IDR/IDA) to modify the subscriber data by removing and/or adding one or more subscriber profile parameters.

As described herein, to take advantage of the roaming wireless communication technologies, a network system may selectively modify subscriber data to enable/disable roaming services for user equipment (UE) on a roaming network. For instance, the system may detect the UE has traveled outbound to a visited country and determine an associated subscriber account information is needed to direct roaming traffic to a preferred partner network. The system, via a home network server, may modify subscriber data to enable/disable roaming services and transmit the subscriber data to a roaming network with instructions to disable data roaming or to register the UE for the preferred partner network.

The systems and methods described herein can be used to selectively modify subscriber data, by a network system, to enable/disable roaming services for outbound UEs by accessing associated subscriber account information. As noted above, the system may configure the subscriber account information to include an account type and/or account indicators to indicate roaming services allowed, including data roaming and/or other network services. Based on the subscriber account information, the system may default to blocking a large portion of roaming subscribers from running up an extremely high phone bill due to a high-cost data roaming network, while selectively unblocking a small portion of the roaming subscribers to enable data roaming for subscribers with certain account type and/or account indicators. This optimizes network use and improves charging logic because customers do not want to inadvertently use high-cost data roaming; thus, network bandwidth use and customer experience are improved. Moreover, by allowing the network to access subscriber account information to determine whether to block or unblock access to roaming network services, the system may refrain from performing unnecessary communication session data transmission, which reduces network bandwidth usage. These and other improvements to the functioning of a computer and network are discussed herein.

In some examples, the techniques discussed herein can be implemented in the context of protocols associated with one or more of 3G, 4G, 4G LTE, 5G protocols. In some examples, the network implementations can support standalone architectures, non-standalone architectures, dual connectivity, carrier aggregation, etc. Example implementations are provided below with reference to the following figures.

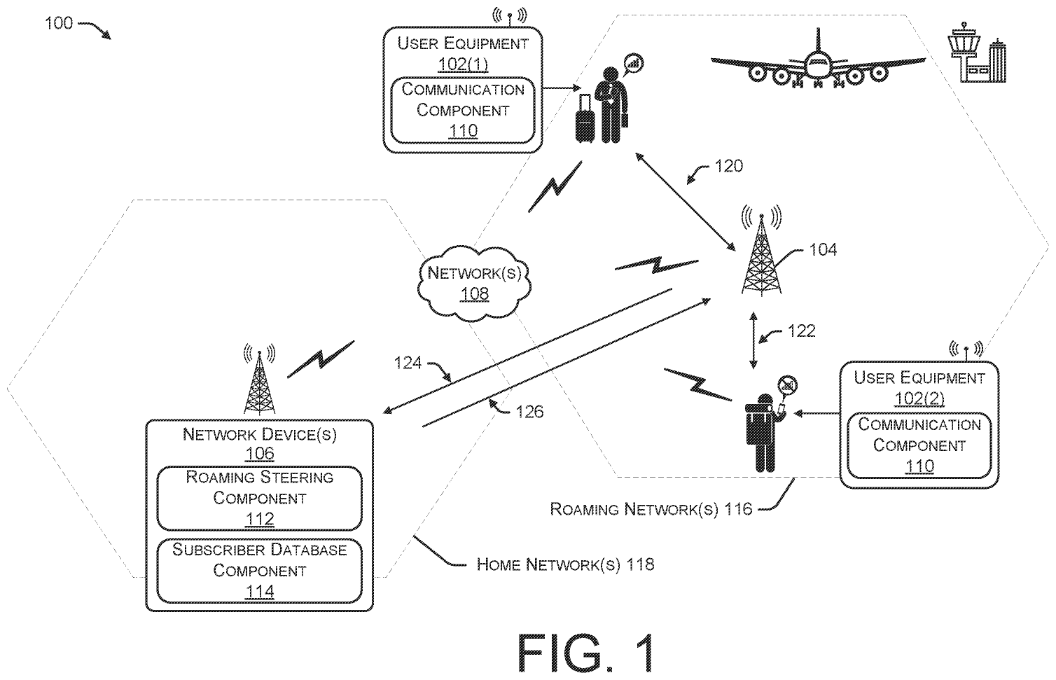

FIG. 1 illustrates an example system 100, including user equipment and networks configured to selectively block subscriber data while roaming.

The user equipment (UE) 102(1) and user equipment (UE) 102(2) (collectively referred to as UE 102) can communicatively connect with other devices, including devices associated with base station 104 and network device(s) 106, via one or more network(s) 108. In an example, the example system 100 shows UE 102(1) and UE 102(2) arriving at a roaming location and attempting to sign onto the roaming network(s) 116 by connecting to base station 104 via a telecommunication network to access enabled network services. The network services may include communication sessions for voice calls, video calls, messaging, emails, browsing, and/or any other type of data transfer. The UE 102 can be any interworking device that can connect and communicate with roaming network(s) 116 and home network(s) 118. In some examples, the UE 102 can be a mobile phone, such as a smartphone or other cellular phone. In other examples, the UE 102 can be a personal digital assistant (PDA), a media player, a tablet computer, a gaming device, a smartwatch, a hotspot, a personal computer (PC) such as a laptop, desktop, or workstation, or any other type of computing or communication device.

The UE 102 may include a communication component 110. In some examples, the communication component 110 may configure a communication client to support communication data transmission. In some examples, the UE 102 may initiate network access using the communication component to transmit registration data, including identification information and geolocation data for the UE 102.

The communication component 110 may send a registration request for the UE 102, as described herein. In response to sending the registration request to the network (e.g., the roaming network(s) 116), the communication component 110 may receive instructions to block or unblock network services as allocated by the subscriber account profile. The communication component 110 may apply the instructions when communicating via a roaming network. Based on the instructions, the communication component 110 may change the types of communication (e.g., enable/disable text messages and/or voice calls) and data usage allowed. If the instructions indicate the UE 102 is not allowed to use data roaming on the roaming network, the communication component 110 may determine to block data roaming usage but may allow emergency data transfer (e.g., emergency alert broadcasts and/or calls for emergency service).

In some examples, the UE 102 can wirelessly connect to one or more base stations or other access points of the access networks and, in turn, be connected to the network(s) 108 via the base stations (e.g., base station 104) and/or network device(s) 106 and/or other access points. In some examples, the network(s) 108 can include the roaming network(s) 116 and the home network(s) 118. The network(s) 108 can include any generation network(s) and can be a packet core network of an LTE network and/or a 5G core network.

Although only illustrated as network device(s) 106 for the home network(s) 118, any networks (e.g., the roaming network(s) 116 and the home network(s) 118) and any base stations (e.g., base station 104) may be associated with one or more network device(s) 106. The network device(s) 106 can include a roaming steering component 112 and a subscriber database component 114. In some instances, the network device(s) 106 can include implementing one or more communication servers to facilitate communications by and between the various devices in the system 100. That is, the network device(s) 106 can represent any computing devices implementing various aspects of one or more of second, third, fourth generation, and fifth generation (2G, 3G, 4G, and 5G) cellular wireless access technologies, which may be cross-compatible and may operate collectively to provide data communication services.

Global Systems for Mobile (GSM) is an example of 2G telecommunications technologies; Universal Mobile Telecommunications System (UMTS) is an example of 3G telecommunications technologies; Long Term Evolution (LTE), including LTE Advanced, and Evolved High-Speed Packet Access (HSPA+) are examples of 4G telecommunications technologies; and New Radio (NR) is an example of 5G telecommunication technologies. Thus, the base station 104 and the base station associated with the network device(s) 106 may implement GSM, UMTS, LTE/LTE Advanced, and/or NR telecommunications technologies.

In some instances, telecommunication technologies can be referred to generally as radio access technology. Thus, a 5G network can represent 5G radio access technology. The base station 104 and the base station associated with the network device(s) 106 may include, but is not limited to, a combination of: base transceiver stations BTSs (e.g., NodeBs, Enhanced-NodeBs, gNodeBs), Radio Network Controllers (RNCs), serving GPRS support nodes (SGSNs), gateway GPRS support nodes (GGSNs), proxies, a mobile switching center (MSC), a mobility management entity (MME), a serving gateway (SGW), a packet data network (PDN) gateway (PGW), an evolved packet data gateway (e-PDG), an Internet Protocol (LP) Multimedia Subsystem (IMS), or any other data traffic control entity configured to communicate and/or route data packets between the user equipment 102, the base station 104, the network device(s) 106, and/or the network(s) 108. In some embodiments, the base station 104 and the network device(s) 106 may be operated by one or more service providers.

The roaming steering component 112 may include functions to process roaming registration requests, block data roaming usage, and/or determine registration logic. The roaming steering component 112 may perform functions that are not directly related to the routing of communication data through the network but rather to traffic steering for the signal flow. The traffic steering may include directing roaming subscribers to preferred partner networks to benefit from better prices and/or better network quality.

The roaming steering component 112 may include a default roaming policy for each roaming location and determine to selectively modify the default roaming policy based on subscriber account information. In some examples, the roaming steering component 112 may configure a default roaming policy for each roaming location (e.g., data roaming allowed by default for Country A and/or data roaming is barred by default for Country B). The roaming steering component 112 may query subscriber account information and modify subscriber data to selectively enable/disable (block/unblock) a portion of the subscribers in a particular country. In additional and/or alternative examples, the roaming steering component 112 may include a default roaming policy that allows specific network services (e.g., emergency calls and Short Message Service (SMS) text) and may determine to selectively unblock additional network services (e.g., voice calls, Multimedia Messaging Service (MMS) text, and data roaming) in the particular country.

In some examples, before initiating a network registration, the roaming steering component 112 may determine subscriber account information is needed to determine whether the UE is allowed to use services on a partner network. In response to determining the subscriber account information is needed, the roaming steering component 112 may query the subscriber database component 114.

The subscriber database component 114 may configure a database for maintaining subscriber-related information to support the network(s) 108. The subscriber database component 114 can collect data associated with subscriber accounts, subscriber affiliation with an entity (e.g., government account), subscriber sessions, and/or registrations in a database. The subscriber database component 114 may collect and store information specific to the subscriber accounts and subscriptions, including one or more of: authorized user(s), username(s), account identifier, account type, account type indicators, subscription, services, and the like. The subscriber database component 114 can also collect information specific to one or more UEs associated with the subscriber account, including a device type, a device identifier, communications capabilities, and the like. The subscriber database component 114 may receive identification information from the UE 102, including one or more of: Subscriber Identity Module (SIM), Mobile Station International Subscriber Directory Number (MSISDN), an International Mobile Subscriber Identity (IMSI), International Mobile Equipment Identity (IMEI), and the like.

The subscriber database component 114 may receive and respond to subscriber account information queries. In some examples, the subscriber database component 114 may receive a query including an account identifier. In response to receiving the query, the subscriber database component 114 may perform a series of checks to determine if the account identifier has an active subscription for the network then determine a response. For instance, the series of checks may include verifying the account identifier is associated with an active subscription, determining a current roaming location (e.g., currently at Country A), determining a default roaming policy for the current roaming location (e.g., default to barring all data roaming for Country A), and determining any default policy changes based on the subscriber account type (e.g., change to allow data roaming based on government account type). The subscriber database component 114 may access subscriber account type indicators to determine whether to block or unblock network services and transmit a response. The subscriber database component 114 may transmit a query response with subscriber account indicators or a Boolean status indicator.

In various examples, the subscriber database component 114 may determine if the subscription information registration indicates support for the query information. For instance, the query information may ask if the account has data roaming and/or the query information may ask for network services enabled and/or restrictions on the network services provided. In some examples, if the subscriber account indicators include the account type and/or the account indicators, the subscriber database component 114 may respond with an affirmative status. Otherwise, the subscriber database component 114 may respond with a negative status. In alternative and/or additional examples, in response to an account query, the subscriber database component 114 may transmit account data associated with the account indicators.

While FIG. 1 illustrates the network(s) 108, including the roaming network(s) 116 and the home network(s) 118, it is understood in the context of this document that the techniques discussed herein may also be implemented in other networking technologies, such as nodes that are part of a wide area network (WAN), metropolitan area network (MAN), local area network (LAN), neighborhood area network (NAN), personal area network (PAN), or the like. Examples of the network(s) 108 can include but are not limited to networks including second-generation (2G), third-generation (3G), fourth-generation (4G) cellular networks, such as LTE (Long Term Evolution), fifth-generation (5G) networks, and data networks, such as Wi-Fi networks.

In some instances, the user equipment (UE) 102 can communicate with any number of user equipment, user devices, servers, network devices, computing devices, and the like.

As a non-limiting example, the example system 100 can illustrate an example process to selectively block subscriber data while roaming. For example, an example UE 102(1) associated with a first user account and an example UE 102(2) associated with a second user account have just arrived at a travel destination (“roaming destination” or “roaming location”), with the example roaming network(s) 116, and the users may have just turned on their UEs or activated network functions (e.g., turn-off “Airplane Mode”).

In the present example, the example UE 102(1) associated with the first user account may be a government official account. The communication component 110 of the example UE 102(1) may transmit a request to establish a connection 120 with an example base station 104.

Additionally, in the present example, the example UE 102(2) associated with the second user account may be a casual subscriber account. The communication component 110 of the example UE 102(2) may transmit a request to establish a connection 122 with the example base station 104.

The example base station 104 may receive the request signal from the example UE 102(1) and/or the example UE 102(2) and may transmit a query 124 to the example home network(s) 118 for instructions on network handling.

The network device(s) 106 associated with the home network(s) 118 may use the roaming steering component 112 and the subscriber database component 114 to determine roaming steering for the example UE 102(1) and/or the example UE 102(2). Initially, the roaming steering component 112 may determine that the example UE 102(1) and/or the example UE 102(2) are roaming based on location data received with the query 124. In some examples, based on the roaming policy for the roaming location, the roaming steering component 112 may generate default roaming subscriber data, including a first subscriber data for the example UE 102(1) and a second subscriber data the example UE 102(2). For instance, the default roaming subscriber data may disable data roaming, by default, for Country A.

The roaming steering component 112 may retrieve associated subscription profiles for network steering at the roaming location. The roaming steering component 112 may query the subscriber database component 114 for the subscription profiles for the UEs and receive a first subscription profile for the first user account and a second subscription profile for the second user account.

In some examples, the roaming steering component 112 may determine, based on the first subscription profile indicating a government account, to modify the first subscriber data to enable data roaming. The roaming steering component 112 may determine, based on the second subscription profile indicating an individual casual subscriber account, not to modify the second subscriber data to prevent high data roaming charges.

In additional examples, the roaming steering component 112 may determine networking handling of the example UE 102(1) using the first subscriber data. For instance, the first subscriber data may include information to select a preferred partner network. The network device(s) 106 may transmit a response 126, including the first subscriber data and the second subscriber data, to the example base station 104 with instructions on network handling. In response, the example UE 102(1) may be registered to connect to the example base station 104, and the example UE 102(2) may be declined from registering to connect with the example base station 104.

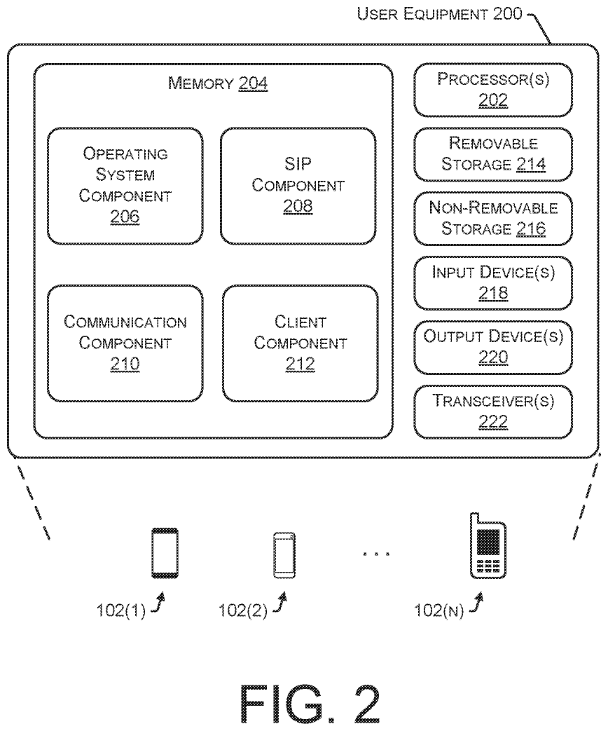

FIG. 2 illustrates an example user equipment 200 configured to implement the client managing components, in accordance with embodiments of the disclosure. In some embodiments, the user equipment 200 can correspond to the user equipment 102 of FIG. 1. It is to be understood in the context of this disclosure that the user equipment 200 can be implemented as a single device or as a plurality of devices with components and data distributed among them. By way of example, and without limitation, the user equipment 200 can be implemented as various user equipment 200(1), 200(2), . . . , 200(N).

As illustrated, the user equipment 200 comprises a memory 204 storing an operating system component 206, a Session Initiation Protocol (SIP) component 208, a communication component 210, and a client component 212. Also, the user equipment 200 includes processor(s) 202, a removable storage 214 and non-removable storage 216, input device(s) 218, output device(s) 220, and transceiver(s) 222.

In various embodiments, the memory 204 is volatile (such as RAM), non-volatile (such as ROM, flash memory, etc.), or some combination of the two. The operating system component 206, the SIP component 208, the communication component 210, and the client component 212 stored in the memory 204 can comprise methods, threads, processes, applications, or any other sort of executable instructions. The operating system component 206, the SIP component 208, the communication component 210, and the client component 212 can also include files and databases.

The operating system component 206 can include functionality to identify and track the different applications installed on the user equipment 200. The operating system component 206 can include functionality to query a chipset of the user equipment 200, and/or query the transceiver(s) 222, to instruct the transceiver(s) 222 and/or any software or hardware to scan one or more channels or frequency resources to determine metrics associated with the channel or frequency resources, for example. In some instances, the operating system component 206 can include an API to receive instructions from one or more of the SIP component 208, the communication component 210, and the client component 212 and to provide data to the corresponding components, including identifying the communication clients and/or communication capabilities of the user equipment 200 and/or a serving network, and notifying the components of clients and/or capabilities. The serving network may include one or more network(s) that the user equipment 200 is currently communicatively connected to. For instance, user equipment 200 may be connected to a 5G cellular network and/or connected to a home Wi-Fi network.

The SIP component 208 may enable communications to be served using SIP instances and/or SIP messages. The SIP component 208 may transmit SIP messages containing information for identifying the user account, user equipment, and/or the communication client to serve a communication session including but not limited to: SIP instance information, access network information, Mobile Station International Subscriber Directory Number (MSISDN), International Mobile Subscriber Identity (IMSI), International Mobile Equipment Identity (IMEI) of the device, Universally Unique Identifier (UUID), called-party-address as Circuit-Switched Routing Number (CSRN), and session description protocol (SDP). The SIP component 208 may use SIP signaling and determine the current location of the user equipment 200 using a Global Positioning System (GPS).

In some examples, a phone mode may be determined based at least in part on a location (e.g., the current geolocation) associated with user equipment 200. For example, if the current location of the user equipment 200 is within a geographic area in which a service provider, associated with an identifier of the user equipment 200, provides coverage, then the phone mode may be set to carrier mode. If the current location of the user equipment 200 is in a geographic area in which the service provider does not provide coverage, then the phone mode may be set to roaming mode. In some examples, the SIP component 208 may determine, based on the phone mode not set to carrier mode, that certain carrier-specific functions may be unavailable, including, but not limited to, selecting certain types of communications or client designations. For instance, the SIP component 208 may determine the user equipment 200 is currently not in carrier mode and may limit access to features and/or services enabled on a roaming network.

The communication component 210 may determine the capability of the user equipment 200 and the serving network to determine the enabled feature information for a communication client (e.g., client component 212). In some examples, in response to registering to a network, the communication component 210 may send, to the network, a publish request to set the enabled feature information of the communication client. While the communication component 210 may send the enabled feature information to the network, it is understood in the context of this document that the user equipment 200 may send and/or receive the enabled feature information via the SIP component 208, the communication component 210, the client component 212, and/or another component. Additionally or alternatively, the user equipment 200 may send the enabled feature information to the network in response to an interrogation poll rather than as a publish request.

The communication component 210 may include functionality to send and receive communications (e.g., voice calls, texts, instant messages, etc.) and/or determine when to transition an existing communication from one access network to another. In some examples, the communication component 210 may perform a number of functions, such as interfacing with the transceiver(s) 222, preparing the user equipment 200 to receive communications, tuning the transceiver(s) 222, receiving and processing an invitation message such as a SIP instance received via the transceiver(s) 222, and the like.

The client component 212 may configure a communication client to send and receive communications. In some examples, the client component 212 may configure some features of the communication client based on the subscriber data associated with the UE 102. The client component 212 may enable or disable features of the communication client, including changing or limiting communication services, based on roaming mode.

In various examples, the client component 212 may generate a user interface to send and receive communication data. The client component 212 may be configured to send and receive communication for one or more subscriber accounts (e.g., personal cellphone, work cellphone, etc.). In some examples, the client component 212 may be configured to use a particular account of the one or more subscriber accounts to originate a communication with and may verify the particular account has the service indicator to enable the communication on a roaming network.

In some embodiments, the processor(s) 202 is a central processing unit (CPU), a graphics processing unit (GPU), or both CPU and GPU, or other processing unit or component known in the art.

The user equipment 200 also includes additional data storage devices (removable and/or non-removable) such as, for example, magnetic disks, optical disks, or tape. Such additional storage is illustrated in FIG. 2 by removable storage 214 and non-removable storage 216. Tangible computer-readable media can include volatile and non-volatile, removable and non-removable media implemented in any method or technology for storage of information, such as computer-readable instructions, data structures, program modules, or other data. Memory 204, removable storage 214, and non-removable storage 216 are all examples of computer-readable storage media. Computer-readable storage media include, but are not limited to, RAM, ROM, EEPROM, flash memory or other memory technology, CD-ROM, digital versatile discs (DVD), content-addressable memory (CAM), or other optical storage, magnetic cassettes, magnetic tape, magnetic disk storage or other magnetic storage devices, or any other medium which can be used to store the desired information and which can be accessed by the user equipment 200. Any such tangible computer-readable media can be part of the user equipment 200.

In various embodiments, the user equipment 200 can include applications including but are not limited to, a web browser application, a video streaming application, an online gaming application, a network analyzer, and the like. During execution on the user equipment 200, each of the applications may be configured to cause the user equipment 200 to initiate communications with a network device (e.g., network device(s) 300) over the network(s) 108.

The user equipment 200 may be configured to communicate over a telecommunications network using any common wireless and/or wired network access technology. Moreover, the user equipment 200 may be configured to run any compatible device operating system (OS), including but not limited to, Microsoft Windows Mobile, Google Android, Apple iOS, Linux Mobile, as well as any other common mobile device OS.

The user equipment 200 also can include input device(s) 218, such as a keypad, a cursor control, a touch-sensitive display, voice input device, etc., and output device(s) 220 such as a display, speakers, printers, etc. These devices are well known in the art and need not be discussed at length here.

As illustrated in FIG. 2, the user equipment 200 also includes one or more wired or wireless transceiver(s) 222. For example, the transceiver(s) 222 can include a network interface card (NIC), a network adapter, a LAN adapter, or a physical, virtual, or logical address to connect to the various network(s) 108, or to the network device (e.g., network device(s) 300), for example. To increase throughput when exchanging wireless data, the transceiver(s) 222 can utilize multiple-input/multiple-output (MIMO) technology. The transceiver(s) 222 can comprise any sort of wireless transceiver capable of engaging in wireless radio frequency (RF) communication. The transceiver(s) 222 can also include other wireless modems, such as a modem for engaging in Wi-Fi, WiMax, Bluetooth, infrared communication, and the like.

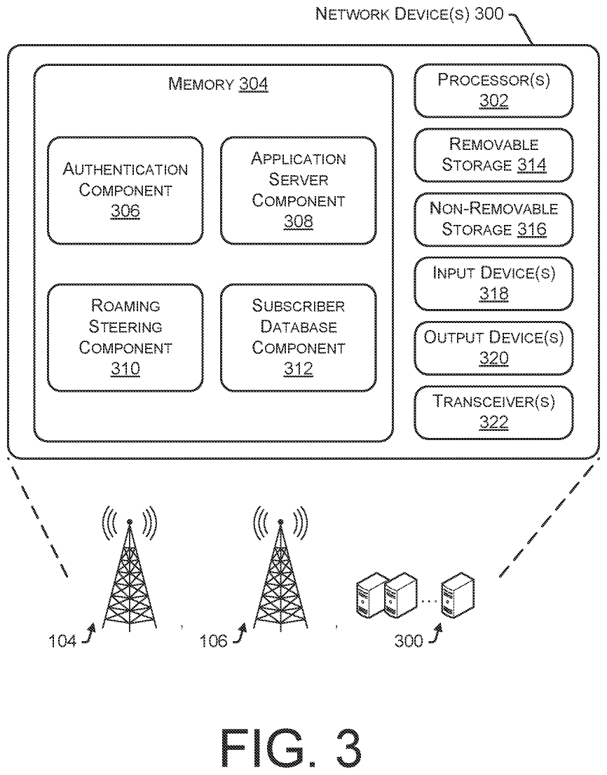

FIG. 3 is a block diagram of a network device(s) 300 selectively block subscriber data while roaming. In some examples, the network device(s) 300 can be configured to implement the techniques discussed herein.

FIG. 3 shows only basic, high-level components of the network device(s) 300. Generally, the network device(s) 300 may comprise and/or may be implemented in any of the various network components discussed herein, including those components illustrated in FIG. 1. For example, the network device(s) 300 may be implemented in the base station 104, a base station associated with the network device(s) 106, the network(s) 108, or other network devices.

In various examples, the network device(s) 300 may include processor(s) 302 and memory 304. Depending on the exact configuration and type of computing device, the memory 304 may be volatile (such as RAM), non-volatile (such as ROM, flash memory, etc.), or some combination of the two. The memory 304 may include an authentication component 306, an application server component 308, a roaming steering component 310, and a subscriber database component 312.

The authentication component 306 can include functionality to identify and/or authenticate UEs, user devices, network devices, and/or any other communications components to interact with the network. The authentication component 306 may receive requests to initiate the UE. The authentication component 306 may authorize the UE to connect to the network by determining that the UE is associated with an active subscription. The authentication component 306 may grant authorization for the services that the UE is allowed to access based on subscription data (e.g., roaming restrictions, account type, etc.) is evaluated once the UE is successfully identified and authenticated. This authorization may be executed during a UE registration procedure.

The authentication component 306 may retrieve data from a user database, data repository, and/or any other database to verify a subscriber account and/or associated UE is authorized to use the services provided by the network device(s) 300. In some examples, the authentication component 306 may include a unified data repository (UDR). The UDR may be a common data repository of subscriber information and can be used to service network functions and/or used to determine the service available to a subscriber. The common data repository can be a shared database providing support for 2G/3G/4G/5G core and can store subscriber data, including subscription service information.

The application server component 308 may include functions to process calls and/or determine call logic. In some examples, the application server component 308 may provide additional multimedia features and can include features like multimedia messaging, video calling, and the integration of multiple devices to a subscriber account. The application server component 308 may perform functions that are not directly related to the routing of communication data through the network but rather determine the signal flow. In various examples, the application server component 308 may use Sh Diameter Interface, or any application protocol, as the interface to communicate with other network components.

The roaming steering component 310 may receive and respond to requests for instructions to direct roaming traffic from roaming networks. In some instances, the roaming steering component 310 can correspond to the roaming steering component 112 of FIG. 1. As described herein, with respect to the roaming steering component 112, the roaming steering component 310 may include functions to process roaming registration requests, block data roaming usage, and/or determine registration logic. In some examples, the roaming steering component 310 may receive a request for subscriber data of an associated UE from a roaming network. The request may include data to identify the UE for the home network. The data may include an account identifier (e.g., SIM profile), a visited country code, and current geolocation data associated with the UE. In some examples, the roaming steering component 310 may determine the UE is at a roaming location based on the current geolocation data and/or based on the visited country code. As described herein, the roaming steering component 310 may determine registration logic for traffic steering at a roaming network. The roaming steering component 310 may determine whether there are one or more partner networks at the roaming location based on the current geolocation data and determine the traffic steering instructions. If there is more than one partner network at the current geolocation data, the traffic steering may direct a roaming UE to a preferred partner network to benefit from better prices and/or better network quality. The traffic steering may include selecting a preferred partner network based on roaming service(s) enabled.

In some examples, the roaming steering component 310 may include a default roaming policy for each roaming location (e.g., by countries) and may selectively modify the default roaming policy based on subscriber account information. For example, the roaming steering component 310 may include a default roaming policy that blocks data roaming for subscribers in a particular country and then may determine to selectively unblock a portion of the subscribers in the particular country. In additional and/or alternative examples, the roaming steering component 310 may include a default roaming policy that allows specific network services (e.g., emergency calls and Short Message Service (SMS) text) and may determine to selectively unblock additional network services (e.g., voice calls, Multimedia Messaging Service (MMS) text, and data roaming) in the particular country.

In some examples, before steering the network traffic, the roaming steering component 310 may query the subscriber database component 312. The roaming steering component 310 may determine that subscriber account information is needed to determine whether the UE and/or associated account identifier is allowed to use roaming services on a partner network.

In various examples, the roaming steering component 310 may receive subscriber account information and, based on the subscriber account information, may modify (e.g., enable/disable or block/unblock) subscriber profile parameter(s) in the subscriber data. In some examples, the roaming steering component 310 may use a Diameter Interface, or any application protocol, as the interface to communicate with other network components. To modify and/or edit the subscriber profile parameter in the subscriber data, the roaming steering component 310 may call commands to Insert Subscriber Data-Request/Answer (IDR/IDA) in the Diameter application. The roaming steering component 310 may respond to the requests for instructions to direct roaming traffic from roaming networks by transmitting the subscriber data for registering UE on a partner network.

As described herein, the roaming steering component 310 may determine that the subscriber account information is needed. In response to the determination, the roaming steering component 310 may query the subscriber database component 312.

The subscriber database component 312 can collect data associated with subscriber accounts in a database and respond to account queries. In some instances, the subscriber database component 312 can correspond to the subscriber database component 114 of FIG. 1. As described herein with respect to the subscriber database component 114, the subscriber database component 312 may configure a database for maintaining subscriber-related information to support the networks. The subscriber database component 312 can collect data associated with subscriber accounts, subscriber affiliation with an entity (e.g., government account), subscriber sessions, and/or registrations in a database. In various examples, the subscriber database component 312 may utilize a common data repository, a shared database providing support for 2G/3G/4G/5G core, to store subscriber-related data, including subscriber account information. The subscriber database component 312 may collect and store information specific to the subscriber accounts and subscriptions, including one or more of: authorized user(s), username(s), an affiliated entity, account identifier, account type, account type indicators, subscription, services, and the like. The subscriber database component 312 can also collect information specific to one or more UEs associated with the subscriber account, including a device type, a device identifier, communications capabilities, and the like. The subscriber database component 312 may receive identification information from the UE, including one or more of: Subscriber Identity Module (SIM), Mobile Station International Subscriber Directory Number (MSISDN), an International Mobile Subscriber Identity (IMSI), International Mobile Equipment Identity (IMEI), and the like.

In some examples, the subscriber database component 312 may receive and respond to subscriber account information queries. In some examples, the subscriber database component 312 may receive a query including an account identifier. In response to receiving the query, the subscriber database component 312 may perform a series of checks to determine if the account identifier has an active subscription for the network then determine a response. For instance, the series of checks may include verifying the account identifier is associated with an active subscription, determining a current roaming location (e.g., currently at Country A), determining a default roaming policy for the current roaming location (e.g., default to barring all data roaming for Country A), and determining any default policy changes based on the subscriber account type (e.g., change to allow data roaming based on government account type). The subscriber database component 312 may access subscriber account type indicators to determine whether to block or unblock network services and transmit a response.

In various examples, the subscriber database component 312 may determine if the subscription information registration indicates support for the query information. The subscriber database component 312 may transmit a query response with subscriber account indicators or a Boolean status indicator. If the subscriber account indicators include the account type and/or the account indicators, the subscriber database component 312 may respond with an affirmative status. Otherwise, the subscriber database component 312 may respond with a negative status. In alternative and/or additional examples, in response to an account query, the subscriber database component 312 may transmit account data associated with the account indicators.

The subscriber database component 312 may receive a subscription account query to determine roaming service access for a roaming UE, as discussed herein. The subscribe request may include information to identify the roaming UE, including one or more of: account identifier, username, Mobile Station International Subscriber Directory Number (MSISDN), an International Mobile Subscriber Identity (IMSI), and the like.

In some examples, the processor(s) 302 is a central processing unit (CPU), a graphics processing unit (GPU), both CPU and GPU, or other processing unit or component known in the art. Furthermore, the processor(s) 302 may include any number of processors and/or processing cores. The processor(s) 302 is configured to retrieve and execute instructions from the memory 304.

The memory 304 can also be described as non-transitory computer-readable media or machine-readable storage memory and may include removable and non-removable media implemented in any method or technology for storage of information, such as computer-executable instructions, data structures, program modules, or other data.

The memory 304 may include, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other tangible, physical medium which can be used to store the desired information.

The network device(s) 300 also includes additional data storage devices (removable and/or non-removable) such as, for example, magnetic disks, optical disks, or tape. Such additional storage is illustrated in FIG. 3 by removable storage 314 and non-removable storage 316. Tangible computer-readable media can include volatile and non-volatile, removable and non-removable media implemented in any method or technology for storage of information, such as computer-readable instructions, data structures, program modules, or other data. The memory 304, the removable storage 314, and the non-removable storage 316 are all examples of computer-readable storage media. Computer-readable storage media include, but are not limited to, RAM, ROM, EEPROM, flash memory or other memory technology, CD-ROM, digital versatile discs (DVD), content-addressable memory (CAM), or other optical storage, magnetic cassettes, magnetic tape, magnetic disk storage or other magnetic storage devices, or any other medium which can be used to store the desired information and which can be accessed by the network device(s) 300. Any such tangible computer-readable media can be part of the network device(s) 300.

The memory 304, the removable storage 314, and/or the non-removable storage 316 may in some cases include storage media used to transfer or distribute instructions, applications, and/or data. In some cases, the memory 304, the removable storage 314, and/or the non-removable storage 316 may include data storage that is accessed remotely, such as network-attached storage that the network device(s) 300 accesses over some type of data communications network.

In various examples, any or all of the memory 304, the removable storage 314, and/or the non-removable storage 316 may store programming instructions that, when executed, implement some or all of the function functionality described herein.

The network device(s) 300 also can include input device(s) 318, such as a keypad, a cursor control, a touch-sensitive display, a voice input device, etc., and output device(s) 320 such as a display, speakers, printers, etc. These devices are well known in the art and need not be discussed at length here.

As illustrated in FIG. 3, the network device(s) 300 also includes one or more wired or wireless transceiver(s) 322. For example, the transceiver(s) 322 can include a network interface card (NIC), a network adapter, a LAN adapter, or a physical, virtual, or logical address to connect to various networks, devices, or components illustrated in figures herein. To increase throughput when exchanging wireless data, the transceiver(s) 322 can utilize multiple-input/multiple-output (MIMO) technology. The transceiver(s) 322 can comprise any sort of wireless transceiver capable of engaging in wireless radio frequency (RF) communication. The transceiver(s) 322 can also include other wireless modems, such as a modem for engaging in Wi-Fi, WiMAX, Bluetooth, infrared communication, and the like.

In some examples, the network device(s) 300 can be implemented as the base stations 104 and the network device(s) 106, including the roaming steering component 112 and/or the subscriber database component 114.

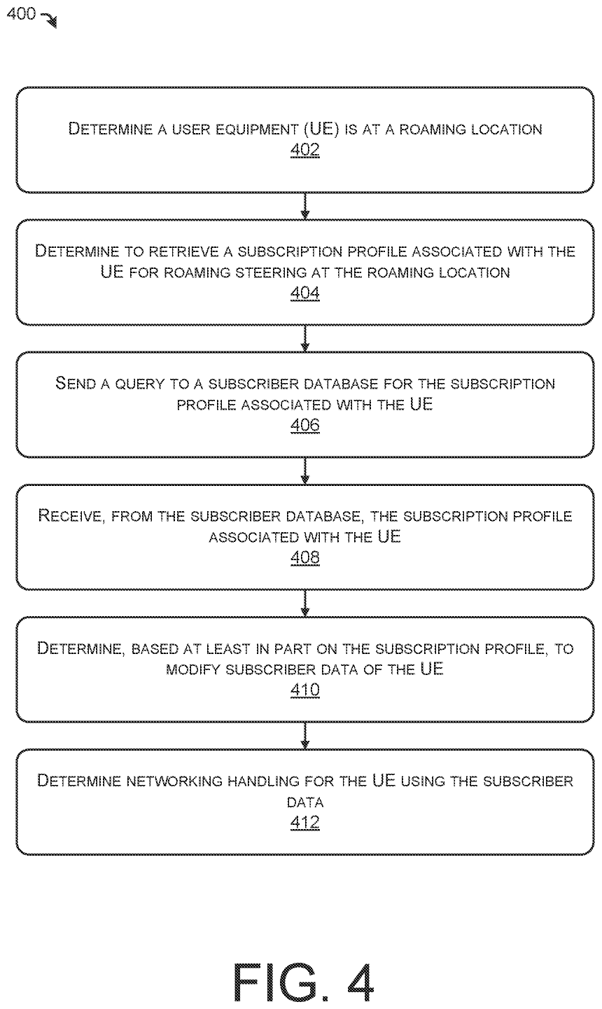

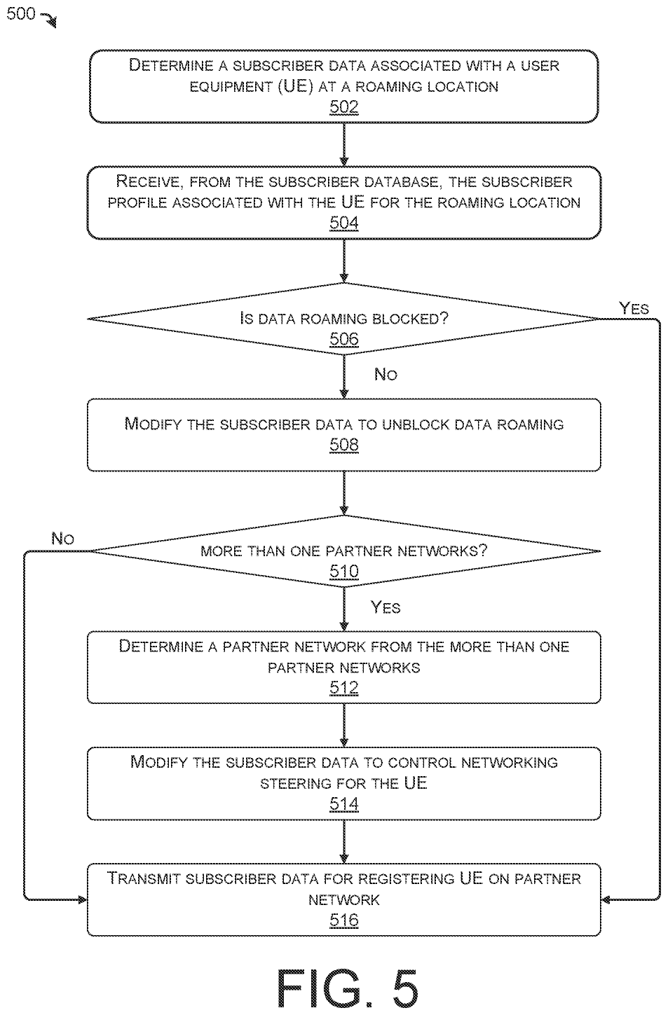

FIGS. 4 and 5 illustrate example processes and sequence diagrams in accordance with examples of the disclosure. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order, omitted, and/or performed in parallel to implement the processes.

FIG. 4 illustrates an example process 400 for selectively blocking subscriber data while roaming. The example process 400 can be performed by the base station 104, the network device(s) 106, and/or by the network device(s) 300 comprising the roaming steering component 310, the subscriber database component 312, or another component or device as discussed herein.

At operation 402, the process can include determining a user equipment (UE) is at a roaming location. As described herein, the roaming steering component may receive a request for subscriber data of an associated UE from a roaming network. The request may include data to identify the UE for the home network. The data may include an account identifier (e.g., SIM profile), a visited country code, and current geolocation data associated with the UE. In some examples, the roaming steering component may determine the UE is at a roaming location based on the current geolocation data and/or based on the visited country code.

At operation 404, the process can include determining to retrieve a subscription profile associated with the UE for roaming steering at the roaming location. As described herein, before steering the network traffic, the roaming steering component may query the subscriber database component. The roaming steering component may determine that subscriber account information is needed to determine whether the UE and/or associated account identifier is allowed to use roaming services on a partner network.

At operation 406, the process can include sending a query to a subscriber database for the subscription profile associated with the UE. As described herein, the roaming steering component may determine that the subscriber account information is needed. In response to the determination, the roaming steering component 310 may query the subscriber database component.

At operation 408, the process can include receiving, from the subscriber database, the subscription profile associated with the UE. As described herein, the roaming steering component may query the subscriber database component. The roaming steering component may determine that subscriber account information is needed to determine whether the UE and/or associated account identifier is allowed to use roaming services on a partner network. In various examples, the roaming steering component may receive subscriber account information and, based on the subscriber account information, may modify (e.g., remove or add) subscriber profile parameter(s) in the subscriber data.

At operation 410, the process can include determining, based at least in part on the subscription profile, to modify subscriber data of the UE. As described herein, the roaming steering component may receive subscriber account information and, based on the subscriber account information, may modify (e.g., remove or add) subscriber profile parameter(s) in the subscriber data. In some examples, the roaming steering component may use a Diameter Interface, or any application protocol, as the interface to communicate with other network components. To modify the subscriber profile parameter in the subscriber data, the roaming steering component may call commands to Insert Subscriber Data-Request/Answer (IDR/IDA) in the Diameter application.

At operation 412, the process can include determining networking handling for the UE using the subscriber data. As described herein, the roaming steering component may include functions to process roaming registration requests, block data roaming usage, and/or determine registration logic. In some examples, the roaming steering component may receive a request for subscriber data of an associated UE from a roaming network. The request may include data to identify the UE for the home network. The data may include an account identifier (e.g., SIM profile), a visited country code, and current geolocation data associated with the UE. In some examples, the roaming steering component may determine the UE is at a roaming location based on the current geolocation data and/or based on the visited country code. As described herein, the roaming steering component may determine registration logic for traffic steering at a roaming network. The traffic steering may include directing roaming subscribers to preferred partner networks to benefit from better prices and/or better network quality. The traffic steering may include selecting a preferred partner network based on roaming service(s) enabled.

FIG. 5 illustrates another example process 500 for selectively blocking subscriber data while roaming. The example process 500 can be performed by the base station 104, the network device(s) 106, and/or by the network device(s) 300 comprising the roaming steering component 310, the subscriber database component 312.

At operation 502, the process can include determining a subscriber data associated with a user equipment (UE) at a roaming location. As described herein, the roaming steering component may receive a request for subscriber data of an associated UE from a roaming network. The request may include data to identify the UE for the home network. The data may include an account identifier (e.g., SIM profile), a visited country code, and current geolocation data associated with the UE. In some examples, the roaming steering component may determine the UE is at a roaming location based on the current geolocation data and/or based on the visited country code.

At operation 504, the process can include receiving, from the subscriber database, the subscriber profile associated with the UE for the roaming location. As described herein, the before steering the network traffic, the roaming steering component may query the subscriber database component. The roaming steering component may determine that subscriber account information is needed to determine whether the UE and/or associated account identifier is allowed to use roaming services on a partner network. In various examples, the roaming steering component may receive subscriber account information and, based on the subscriber account information, may modify (e.g., remove or add) subscriber profile parameter(s) in the subscriber data. In some examples, the roaming steering component may use a Diameter Interface, or any application protocol, as the interface to communicate with other network components.

At operation 506, the process can include determining whether data roaming is blocked. As described herein, the roaming steering component may include a default roaming policy for each roaming location (e.g., by countries) and may selectively modify the default roaming policy based on subscriber account information. For example, the roaming steering component may include a default roaming policy that blocks data roaming for subscribers in a particular country and then may determine to selectively unblock a portion of the subscribers in the particular country. In additional and/or alternative examples, the roaming steering component may include a default roaming policy that allows specific network services (e.g., emergency calls and Short Message Service (SMS) text) and may determine to selectively unblock additional network services (e.g., voice calls, Multimedia Messaging Service (MMS) text, and data roaming) in the particular country. If the data roaming is blocked (e.g., “yes” in operation 506), the process can continue to operation 516. Otherwise, if the data roaming is not blocked (e.g., “no” in operation 506), the process continues to operation 508.

At operation 508, the process can include modifying the subscriber data to unblock data roaming. As described herein, the roaming steering component may receive subscriber account information and, based on the subscriber account information, may modify (e.g., enable/disable or block/unblock) subscriber profile parameter(s) in the subscriber data. In some examples, the roaming steering component may use a Diameter Interface, or any application protocol, as the interface to communicate with other network components.

At operation 510, the process can include determining whether there is more than one partner networks available. As described herein, the roaming steering component may determine registration logic for traffic steering at a roaming network. The roaming steering component may determine whether there are one or more partner networks at the roaming location based on the current geolocation data and determine the traffic steering instructions.

At operation 512, the process can include determining a partner network from the more than one partner networks. As described herein, the roaming steering component may determine registration logic for traffic steering at a roaming network. The roaming steering component may determine whether there are one or more partner networks at the roaming location based on the current geolocation data and determine the traffic steering instructions. If there is more than one partner network at the current geolocation data, the traffic steering may direct a roaming UE to a preferred partner network to benefit from better prices and/or better network quality. The traffic steering may include selecting a preferred partner network based on roaming service(s) enabled.

At operation 514, the process can include modifying the subscriber data to control networking steering for the UE. As described herein, the roaming steering component may receive subscriber account information and, based on the subscriber account information, may modify (e.g., enable/disable or block/unblock) subscriber profile parameter(s) in the subscriber data. In some examples, the roaming steering component may use a Diameter Interface, or any application protocol, as the interface to communicate with other network components. To modify the subscriber profile parameter in the subscriber data, the roaming steering component may call commands to Insert Subscriber Data-Request/Answer (IDR/IDA) in the Diameter application. As described herein, the roaming steering component may determine that the subscriber account information is needed. In response to the determination, the roaming steering component may query the subscriber database component.

At operation 516, the process can include transmitting subscriber data for registering UE on partner network. As described herein, the roaming steering component may receive and respond to requests for instructions to direct roaming traffic from roaming networks. The roaming steering component may determine that subscriber account information is needed to determine whether the UE and/or associated account identifier is allowed to use roaming services on a partner network and query the subscriber database component. The roaming steering component may receive subscriber account information and, based on the subscriber account information, may modify (e.g., enable/disable or block/unblock) subscriber profile parameter(s) in the subscriber data. In some examples, the roaming steering component may use a Diameter Interface, or any application protocol, as the interface to communicate with other network components. To modify the subscriber profile parameter in the subscriber data, the roaming steering component may call commands to Insert Subscriber Data-Request/Answer (IDR/IDA) in the Diameter application. The roaming steering component may respond to the requests for instructions to direct roaming traffic from roaming networks by transmitting the subscriber data for registering UE on a partner network.

### CONCLUSION

Although features and/or methodological acts are described above, it is to be understood that the appended claims are not necessarily limited to those features or acts. Rather, the features and acts described above are disclosed as example forms of implementing the claims.

What is claimed is:

1. One or more non-transitory computer-readable media storing computer executable instructions that, when executed, cause one or more processors to perform operations comprising:
determining that a user equipment (UE) is in a roaming location;
determining to retrieve a subscription profile associated with the UE for network steering at the roaming location;
sending a query to a subscriber database for the subscription profile associated with the UE;
receiving, from the subscriber database, the subscription profile associated with the UE;
determining, based at least in part on the subscription profile, to modify subscriber data of the UE; and
determining networking handling for the UE using the subscriber data.

2. The one or more non-transitory computer-readable media of claim 1, wherein determining to modify the subscriber data of the UE comprises:
removing a subscriber profile parameter from the subscriber data; and
determining to block the UE from accessing a partner network.

3. The one or more non-transitory computer-readable media of claim 1, wherein determining to modify the subscriber data of the UE comprises:
adding a subscriber profile parameter to the subscriber data; and
selecting a partner network to register the UE.

4. The one or more non-transitory computer-readable media of claim 3, wherein the operations further comprise:
registering, based at least in part on the subscriber data, the UE on the partner network.

5. The one or more non-transitory computer-readable media of claim 1, wherein the subscriber data includes subscriber account type indicators associated with service access, wherein the subscriber account type indicators comprises at least one of:
an indication that the UE is has roaming enabled for the roaming location;
one or more service indicators associated with the roaming location; or
a selection of a preferred partner network.

6. A method comprising:
determining that a user equipment (UE) is in a roaming location;
sending, based at least in part on the roaming location, a query to a subscriber database for subscriber data associated with the UE;
receiving, from the subscriber database, the subscriber data associated with the UE;
determining, based at least in part on the subscriber data, to edit a subscriber profile parameter of the UE; and
determining networking handling for the UE using the subscriber data.

7. The method of claim 6, wherein the query to the subscriber database is configured to use a Diameter interface.

8. The method of claim 6, wherein editing the subscriber data includes using commands Insert Subscriber Data-Request/Answer (IDR/IDA).

9. The method of claim 6, wherein the subscriber data comprises at least one of:
an indication that the UE is has roaming enabled for the roaming location;
one or more service indicators associated with the roaming location; or
a selection of a preferred partner network.

10. The method of claim 6, further comprising:
receiving location data associated with the UE;
determining, based at least in part on the location data, the UE is in a second roaming location; and
sending, based at least in part on the second roaming location, a second query to the subscriber database, the second query including the location data.

11. The method of claim 6, wherein the subscriber data includes subscriber account type indicators associated with service access, wherein the subscriber account type indicators comprises at least one of:
an indication that the UE is has roaming enabled for the roaming location;
one or more service indicators associated with the roaming location; or
a selection of a preferred partner network.

12. The method of claim 6, wherein determining to edit the subscriber profile parameter of the UE comprises:
adding the subscriber profile parameter to the subscriber data, the subscriber profile parameter including a selection of a preferred partner network; and
determining, based at least in part on the subscriber data, a partner network from the selection of the preferred partner network to register the UE.

13. The method of claim 6, wherein determining to edit the subscriber profile parameter of the UE comprises:
removing the subscriber profile parameter from the subscriber data; and
determining to block the UE from accessing a partner network.

14. A system comprising:
one or more processors;
a memory; and
one or more components stored in the memory and executable by the one or more processors to perform operations comprising:
determining that a user equipment (UE) is in a roaming location;
sending a query to a subscriber database for subscriber data associated with the UE;
receiving, from the subscriber database, the subscriber data associated with the UE;
determining, based at least in part on the subscriber data, to modify the subscriber data of the UE; and
determining, based at least in part on the subscriber data, to register the UE with a partner network.

15. The system of claim 14, wherein determining the UE is in the roaming location comprises:
determining location data associated with the UE.

16. The system of claim 15, wherein determining the UE is in the roaming location further comprises:
determining to retrieve the subscriber data associated with the UE for network steering at the roaming location.

17. The system of claim 14, wherein the subscriber data includes subscriber account type indicators associated with service access, wherein the subscriber account type indicators comprises at least one of:
an indication that the UE is has roaming enabled for the roaming location;
one or more service indicators associated with the roaming location; or
a selection of a preferred partner network.

18. The system of claim 17, wherein the one or more service indicators includes one or more of voice service, messaging service, and data service.

19. The system of claim 14, the operations further comprising:
receiving location data associated with the UE;
determining, based at least in part on the location data, the UE is in a second roaming location; and
sending, based at least in part on the second roaming location, a second query to the subscriber database, the second query including the location data.

20. The system of claim 14, wherein determining to modify the subscriber data of the UE comprises:
removing a subscriber profile parameter from the subscriber data; and
determining to block the UE from accessing the partner network.
